(19) United States
(12) Patent Application Publication
(10) Pub. No.: US 2010/0188649 A1
(43) Pub. Date: Jul. 29, 2010

(54) Distance measurement device and method of use thereof

(76) Inventors: Scott Prahl, Portland, OR (US); Amanda Dayton, Portland, OR (US)

Correspondence Address: Ingrid McTaggart, 3021 S.E. 56th Avenue, Portland, OR, 97206, US

(21) Appl. No.: 12/657,548

(22) Filed: Jan. 22, 2010

Related U.S. Application Data
(60) Provisional application No. 61/205,836, filed on Jan. 23, 2009.

(51) Int. Cl. G01C 3/08

(52) U.S. Cl. 356/4.07

(57) ABSTRACT

Systems and methods of utilizing a frequency modulation technique to determine an unknown distance between at least one source and at least one detector in an light scattering medium without knowing the optical properties of the medium are described. Modulated light is emitted from a light source to an optical scattering and absorbing medium and at least a portion of the modulated light is detected with a detector. A calibration factor is determined and then an unknown distance between at least one source and at least one detector can be determined, thereby providing a distance measurement.

This application claims the benefit of Provisional application Ser. No. 61/205,836 filed Jan. 23, 2009.

### BACKGROUND OF THE INVENTION

1. Field of the Invention

The present invention relates to a method and system for measuring an unknown distance between an optical source and a detector in a light scattering and absorbing medium. The determination of the unknown distance between an optical source and a detector may be useful in many fields such as in medicine and in manufacturing.

2. Background of the Invention

The frequency domain technique of modulating a light source and detecting the light that has traveled though a scattering medium to determine characteristics of the medium has been used in many different ways. The devices that utilize this technique require at least one source and one detector at a known distance apart. Existing devices cannot be used for measurement of an unknown and changeable distance and cannot be used to determine characteristics of a medium when the source and the detector are spaced apart an unknown distance.

### OBJECTS OF THE INVENTION

It is an object of this invention to provide a device and method that allows the determination of an unknown distance measurement through a light scattering medium.

### SUMMARY OF THE INVENTION

The present invention utilizes a frequency modulation technique to determine the distance between at least one source and at least one detector. In one example embodiment, the intensity of a diode laser is modulated with a sine wave at a predetermined frequency or many frequencies. As the modulated light travels through the medium the overall intensity of the signal, as well as the amplitude of the modulated wave, decreases. In addition, the phase of the modulated wave is retarded. The light travels through an optical scattering and absorbing medium and is collected by a small handheld probe spaced an unknown distance from the light source. After a calibration factor has been determined, the unknown distance the light has traveled can be determined, thereby providing a distance measurement.

### BRIEF DESCRIPTION OF THE DRAWINGS

FIG. 1 is a schematic diagram of one example embodiment of a distance measurement device including two light sources and two detectors positioned on a scattering medium of interest.

FIG. 1 is a schematic diagram of one example embodiment of a distance measurement device including two light sources and two detectors positioned on a phantom medium.

FIG. 3 is a graph of a phase shift as a function of distance.

FIG. 4 is a graph of calculated distance versus actual distance to show the accuracy of the present inventive device and method.

### DETAILED DESCRIPTION OF THE EMBODIMENTS

Frequency domain optical techniques have been used to measure the optical properties of a medium. The optical properties can then be used to create images or spectra for characterization of the medium. In contrast to the devices and/or methods disclosed in prior art, the present invention provides a device and method for measuring an unknown distance between a source and a detector spaced apart without knowing the optical properties of the medium through which the light travels

The present invention provides a method and system that allows the measurement of an unknown distance between a source and a detector that are movable with respect to each other. The determination of the distance between a source and a detector may be useful in many fields such as in medicine and in manufacturing.

The distance measurement device of the present invention provides an optical method to measure the distance between two points in a scattering medium, wherein such a device and method has heretofore not been available. To accomplish the distance measurement: 1) the intensity of a light source may be modulated with a sine wave 2) the modulated light may travel through an optically scattering and absorbing medium 3) a portion of the light may be optically detected by a detector 4) the change in the modulated light (i.e. the change in phase and/or modulation) may be measured at a known distance between the source and detector 5) one or more of these measurements may be used to determine a calibration factor 6) additional measurements of the change in phase and/or modulation at unknown distances from the source light may be made with the detector 7) the distance between the source and the detector may be calculated using the additional measurement. The optical source may be positioned on the surface or may be imbedded in the medium. The optical detector may be positioned on the surface or may be imbedded in the medium. Moreover, multiple sources and/or multiple detectors may be utilized, wherein the sources and detectors may be positioned on or in the medium, in a variety of combinations of positions.

The calibration factor may be determined in several ways. It is assumed that the instruments have been adjusted to negate the contribution of the instrumentation to the change in phase and/or modulation. One embodiment of determining the calibration factor may be performed by measuring the change in modulated light on a phantom medium with known optical properties at a known source to detector distance. Another embodiment of determining the calibration factor may be to measure the change in modulated light in the medium of interest at one known source to detector distance. One or more calibration factors may be determined on the medium of interest and/or the phantom medium of known optical properties in a plurality of combinations.

Additional improvements in accuracy may arise from repeatedly measuring the change in phase and/or modulation at one modulation frequency or from measuring the change in phase and/or modulation at many modulation frequencies.

A linear relationship between the distance between the source and detector and the change in phase and/or modulation exists when the frequency of modulation, f, hertz (Hz) is much less than the product of the absorption coefficient, μₐ, inverse millimeters (mm⁻¹) and speed of light in the medium, c, millimeters per second (mm/s).

f<<μₐc (Equation 1)

When Equation 1 is satisfied, the distance between the source and the detector can be described by

R=α(1/f)φ (Equation 2)

R=β(1/f²)ln(M) (Equation 3)

Equation 2 describes the linear relationship between distance, R, and change in phase, where φ is the measured change in phase between the source and detector, f is the frequency of modulation, and α is a calibration factor independent of frequency that depends on the properties of the scattering and absorbing medium. Equation 3 describes the linear relationship between the distance and the natural logarithm of the change in modulation, where M is the modulation amplitude which depends on the overall intensity of the light source, DC_{S}, and detected light, DC_{d}, as well as the amplitude of the wave at the source, Aₛ, and the detector, A_{d}

M=(AC_{d}/DC_{d})/(ACₛ/DCₛ) (Equation 4)

and β is the calibration factor independent of frequency that depends on the properties of the scattering and absorbing medium.

The advantages of the present invention are numerous. The device and method may be used to nondestructively measure an unknown distance through a light scattering medium, and may be used with visible or non-visible light. In one example embodiment, a light source placed within the medium creates an illuminated region, or glowball, surrounding the source that can serve as a guide for localization or removal of a targeted volume. Light coupling, ambient lighting, eye sensitivity, as well as the optical properties and homogeneity of the medium may affect the perceived size of the glowball. This variability in perceived size may be eliminated with quantitative measurements of the unknown distance between the optical source and an optical detector. By measuring changes in the modulated light, the unknown distance between the source and the detector can be calculated. Accordingly, the device and method may be used to determine the unknown distance to a targeted area in a medium, such as during surgical removal of diseased tissue. Details of the embodiments will now be described.

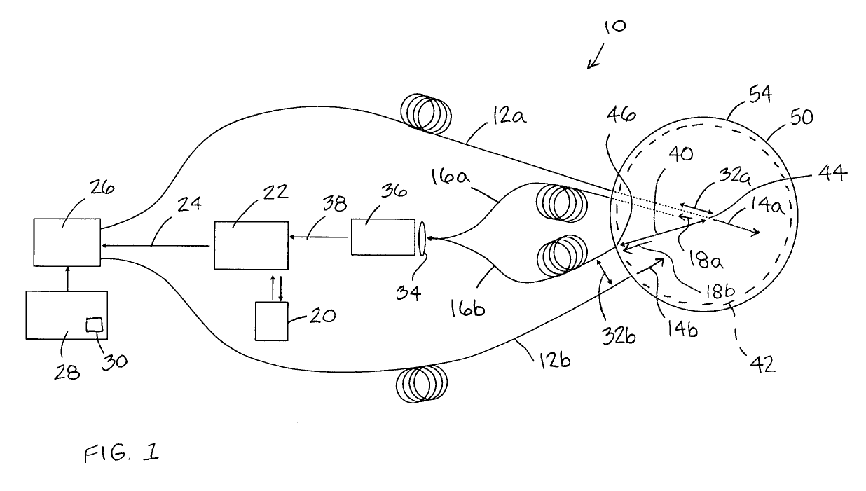

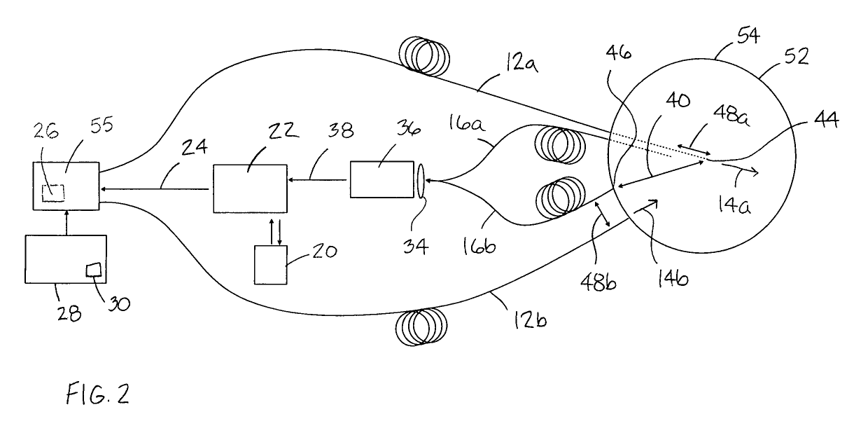

FIG. 1 is a schematic of one preferred embodiment of a system 10 utilized to measure the unknown distance between a light source 12a, such as an optical fiber, that emits intensity modulated light 14a, and a light detector 16a, that detects the resulting scattered light 18a. In the figures, for ease of illustration, detected scattered light 18 is indicated by a single arrow 18 along a straight path. Those skilled in the art, however, will understand that detected scattered light 18 follows a non-linear scattering path. One or more sources 12a, 12b, etc. and one or more detectors 16a, 16b, etc. may be used to emit intensity modulated light 14a, 14b, and to detect the scattered intensity modulated light 18a and 18b, respectively. In the embodiment shown, a control unity comprises: a central processing unit (CPU), or computer 20, which may run a software program, such as LabView (Registered Trademark of National Instruments) to drive a network analyzer 22 between 100 and 200 mega hertz (MHz), for example. A frequency modulated signal 24 from the network analyzer 22 may be fed into a laser diode 26, which may also be biased by a DC current from a laser diode driver 28. The laser 26 may be regulated with a temperature control 30 within or attached to or separate from driver 28 and may be operatively coupled to optical source fibers. In this illustration, sources 12a and 12b are optical fibers and may have light diffusing tips on their light emitting ends to create more isotropic light sources. Sinusoidally intensity modulated light 14a and 14b, respectively, may be emitted from the tip(s) of sources 12a and 12b. The detector(s), 16a and 16b, may collect light 18a and 18b, respectively, that has traveled distance(s), 32a and 32b, respectively. In this example as described, for ease of illustration, detector 16a detects light 18a emitted by source 12a. However, in other embodiments, detector 16a may detect light 18b emitted by source 12b or may detect light 18a and light 18b, in a staggered time detection technique or optical filtering technique, emitted from both of sources 12a and 12b, for example.

After detection of scattered light 18, the detector 16 may then send this collected light into a focusing lens system 34 and then into an avalanche photo diode, (APD) 36, which may have an adjustable gain. The APD 36 may convert the light signal received, such as detected light 18a and 18b, to a voltage 38 which may then be fed back into the network analyzer 22 where the phase lag and/or amplitude of the light signal 18a, 18b, may be measured. The change in phase and/or modulation of the light signal 18a, 18b, may be used to determine a calibration factor based on a known distance between the source and detector fibers 12a, 12b, and 16a, 16b, for example. The calibration factor may be determined by dividing the change in phase or modulation by a known distance between the sources and detectors 12a, 12b and 16a, 16b, for example. By multiplying the calibration factor with a measured change in the modulated light at an unknown distance 40, between a tip 44 of a particular source 12a, for example, and a tip 46 of a particular light detector 16b, for example, an unknown distance 40, may be measured. The DC current utilized to drive the diode laser 26 may be adjusted to control the size of a glowball 42 (shown in dash lines) generated within a light scattering medium 50 by modulated light 14a, for example. In other embodiments, other combinations of sources and detectors may be utilized, such as use of a single detector with multiple light sources, a single light source with multiple detectors, two sources with and three detectors, two sources with four detectors, etc. Additionally, other variables may be changed such as the wavelength of the source light utilized. For example, source 12a may be a different wavelength of light than 12b but may be modulated at the same frequency or a different frequency. Or, for example, source 12a by emit one or more wavelengths of light. The source, 12 may be illuminated by a laser or light emitting diode that emits a small range of wavelengths of light. Accordingly, the variety of combinations of variables may be infinite to determine an unknown distance 40 between the light source and the detector.

Reference numbers 32a, 32b, 32c, etc. may be utilized to describe the known distance that modulated light travels, and reference number 40 may be utilized to describe the unknown distance between a particular source/detector pair, wherein unknown distance 40 may coincide with a particular light travel path 32. In other words, multiple measurements may be conducted to determine a single distance 40 between a particular light source 12 and a particular detector 16 of interest, for example, or to determine a single distance 40 between a particular position of a light source 12 and a particular position of a detector 16. As stated earlier, distance 32 traveled by modulated light 18 is shown schematically by reference arrow 18 because scattered light does not follow a linear path in a scattering medium.

Each of the different embodiments may be conducted at one or many wavelengths of light in the visible or non-visible range and may be conducted with a variety of numbers of sources 12 and detectors 16 and at one or more modulation frequencies. An example method will now be described in detail.

FIG. 2 shows system 10 utilized to determine the calibration factor of the method. One embodiment of the determination of the calibration factor includes conducting one or more measurements of the medium at known and different source-detector separation distances 48a and/or 48b, for example, and may be conducted in a phantom medium 52, i.e., a homogenous medium physically separate from the medium of interest 50 (FIG. 1) but having similar optical properties. In another embodiment, this determination of the calibration factor may be conducted on the medium of interest 50 (FIG. 1). In another embodiment, determination of the calibration factor in the phantom medium 52, as well as at least one additional adjustment to the calibration factor in the medium of interest 50 (FIG. 1), at a known source-detector separation distance 48 may be conducted to improve the accuracy of the measurement of unknown distance 40. The determination of the calibration factor at the known source-detector separation distance 48 may be accomplished using a surface measurement device if the source 12 and detector 16 are both placed on the surface 54 of the medium 50 (FIG. 1) or 52, for example, and may involve a surface source 12 or detector 16, for example, if one or more of the source 12 and detector 16 are positioned imbedded within the medium, 50 (FIG. 1) or 52. A method to determine an unknown distance measurement 40 between a tip 44 of a particular source fiber 12 and a tip 46 of a particular light detector 16, for which a distance measurement 40 may be desired, will be discussed below.

After the calibration factor has been determined, a measurement of a change in the modulated light to determine the unknown distance 40, between source 12, and detector 16, is conducted. The measurement to determine the unknown source-detector separation distance 40 is conducted within the medium of interest 50 (FIG. 1) and may be made with a plurality of source-detector geometries. For example, the source or sources 12 may be in contact with, imbedded in or positioned on the surface 54 of the medium of interest 50. The detector or detectors 16 may be in contact with, imbedded in or positioned on the surface 54 of the medium of interest 50. One or more sources 12 and detectors 16 may be used with a plurality of different wavelengths of light 14 or frequencies of modulation. Filtering the light 14 or 18 to select specific wavelengths of light or frequencies of modulation, as well as time resolved staggering of which source-detector combination is analyzed, are additional variables that may be utilized in other embodiments.

After the determination of the calibration factor and measurement of a change in the modulated light over unknown distance 40, the unknown distance 40, is determined. In a preferred embodiment, the most straightforward method of calculating the unknown distance between the source and detector, R, 40, utilizes the linear response of the change in phase of the detected light 18 to a change in the source to detector separation distance, as shown in Equation 2. The more calibration factors that are determined, i.e., the more sources and detectors utilized and the more measurements taken utilizing different source and detector combinations, the more accurate the calculation of the calibration factor, α, will be.

Another embodiment involves utilizing multiple modulation frequencies. Yet another embodiment involves utilizing equation 3 and measuring the change in modulation in addition to or in place of the change in phase of the signal. The calibration factor β, has a linear response to the natural logarithm of the change in normalized modulation.

A prototype was developed and testing of the inventive device 10 and method was conducted. In particular, a polyurethane phantom medium 52 (FIG. 2) was created to test the device 10. India ink (PRO ART of Beaverton, Oreg.) and titanium dioxide (Sigma, of St. Louis Mo.) were added to polyurethane components (BJB Enterprises, Inc.), which were then mixed and allowed to cure. One hole was drilled axially in the cylindrical polyurethane phantom medium 52 at a depth of 9 mm deep and 5 mm from the edge. Phase shift measurements were made at the surface 54 of the phantom 52 in a plane with the light source 12.

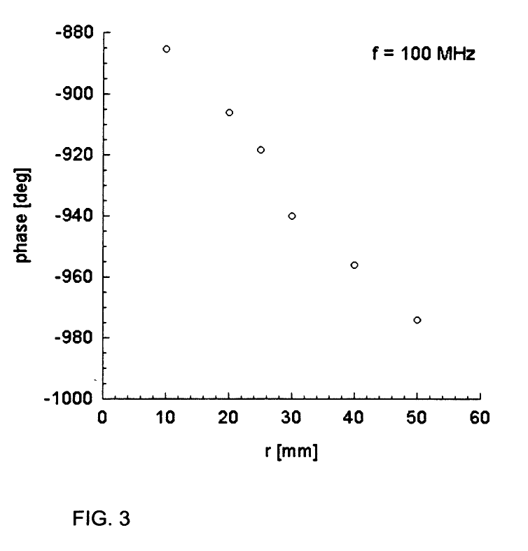

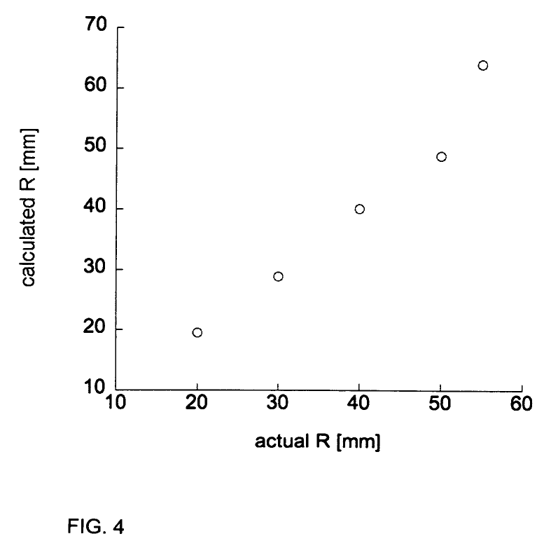

To calculate the distance, R, 40, between the source 12 and the detector 16 based on phase measurements, a system was constructed based on FIG. 2. A network analyzer 22 (manufactured by Hewlett Packard, 8752C) generated a radio frequency (RF) modulated signal 38, swept between 100 and 150 mega hertz (MHz). The RF signal 38, was delivered to a laser diode mount 55 (ThorLabs, TCLDM9) on which a 638 nanometer (nm) fiber pigtailed laser diode 26 (Sanyo, DL7032-001) was mounted. The laser diode 26 was also biased by direct current from the driver 28 (ThorLabs, LDC 210) and the temperature of the diode 26 was held at 25 degrees Celsius (deg. C.) by a temperature controller 30 (ThorLabs, TEC200). The sinusoidally modulated light 14 was delivered within an optical phantom 52 through a 195 micrometer (μm) diameter optical source fiber 12a and detected with an 1000 μm diameter optical detector fiber 16b. The intensity modulated light may include at least one wavelength at a frequency less than 1000 mega hertz. The detected signal 18 was focused onto an avalanche photodiode, APD 36, (ThorLabs, APD 210) where it was converted to a voltage and fed back into the network analyzer 22. The calibration factor of the system 10 was determined by measuring the phase shift with the source 12 and detector 16 fibers at distances of 15 and 25 millimeters (mm) apart, respectively. The phase shift was also recorded at 20, 30, 40, 50 and 55 mm apart, and is shown in FIG. 3. The calculated calibration measurements were used to predict the distance 40 the light 18 had traveled, as shown in FIG. 4.

Accordingly, the feasibility of a frequency domain system that determines a calibration factor based on two known source detector separation distances utilizing measurements of phase shift and then extrapolates that calibration factor to determine an unknown distance 40 was demonstrated. In an optical phantom 52, sinusoidally modulated light 14 within the scattering medium 52 was used to measure the phase shift at a known distance 32 between source 12 and detector 16 and predict the unknown distance 40 between source 12 and detector 16 upon moving detector 16 to a different location on scattering medium 52. The prediction of an unknown distance 40 from the source 12 to the detector 16 was within 3% of the actual distance (FIG. 4) in the phantom medium 52.

Other variations and modifications of the concepts described herein may be utilized and fall within the scope of the claims below.

We claim:

1. A method of measuring a distance in a light scattering medium, comprising:
emitting, by a light source, intensity modulated light, wherein the light source is positioned at a first location in contact with a light scattering medium;
detecting, by a detector, at least a portion of the intensity modulated light, wherein the detector is positioned at a second location in contact with the light scattering medium; and
calculating the distance between the first location and the second location based at least in part on an observed change in the intensity modulated light.

2. The method of claim 1 wherein the light scattering medium modifies at least a portion of the intensity modulated light, wherein said modification is caused by one of absorption and scattering.

3. The method of claim 1 wherein the intensity modulated light comprises at least one of visible and non-visible light.

4. The method of claim 1 wherein the light source and the detector are movably positionable with respect to one another.

5. The method of claim 1 wherein the intensity modulated light comprises at least one wavelength at a frequency less than 1000 mega hertz.

6. The method of claim 1 wherein the observed change in the intensity modulated light is proportional to a change in distance between the light source and the detector.

7. The method of claim 1 wherein the observed change in the intensity modulated light comprises a phase shift.

8. The method of claim 1 wherein the observed change in the intensity modulated light comprises a logarithm of a decrease in modulation amplitude.

9. The method of claim 1 wherein the intensity modulated light comprises a plurality of wavelengths.

10. The method of claim 1 wherein said calculating step comprises multiplying the observable change in the intensity modulated light by a calibrating factor.

11. The method of claim 10 further comprising calculating the calibrating factor by dividing the observed change in the intensity modulated light by a known distance in the light scattering medium.

12. The method of claim 11 wherein said light source and said detector are each placed in contact with a first scattering medium when determining said calibrating factor, and wherein said light source and said detector are each placed in contact with a second scattering medium during said measurement.

13. The method of claim 11 wherein a plurality of said calibrating factors are determined for a corresponding plurality of scattering mediums.

14. A system for measuring a distance in a light scattering medium, comprising:
a light source that emits intensity modulated light and is positioned at a first location in contact with a light scattering medium;
a light detector that detects at least a portion of the intensity modulated light and is positioned at a second location in contact with the scattering medium; and
a calculation module that calculates a distance between the first location and the second location based at least in part on an observed change in the intensity modulated light.

15. The system of claim 14 wherein the observed change in the intensity modulated light comprises a phase shift.

16. The system of claim 14 wherein the observed change in the intensity modulated light correlates to a natural logarithm of a decrease in amplitude.

17. The system of claim 14 wherein the light scattering medium modifies at least a portion of the intensity modulated light, wherein said modification is caused by one of absorption and scattering.

18. The system of claim 14 wherein the intensity modulated light comprises at least one of visible and non-visible light.

19. The system of claim 14 wherein the light source and the light detector are movably positionable with respect to one another.

20. The system of claim 14 wherein the intensity modulated light comprises at least one wavelength at a frequency less than 1000 mega hertz.

21. The system of claim 14 wherein the observed change in the intensity modulated light is proportional to a distance between the light source and the light detector.

22. The system of claim 14 wherein the observed change in the intensity modulated light comprises a phase shift.

23. The system of claim 14 wherein the observed change in the intensity modulated light comprises a natural logarithm of a decrease in modulation amplitude.

24. The system of claim 14 wherein the intensity modulated light comprises a plurality of wavelengths.

25. The system of claim 14 wherein said calculating module calculates the distance by multiplying the observable change in the intensity modulated light by a calibrating factor.

26. The system of claim 25 wherein said calculating module calculates the calibrating factor by dividing the observed change in the intensity modulated light by a known distance in the light scattering medium.

27. The system of claim 26 wherein said light source and said light detector are each placed in contact with a first scattering medium when determining said calibrating factor, and wherein said light source and said light detector are each placed in contact with a second scattering medium during said calculating said distance.

28. The system of claim 26 wherein a plurality of said calibrating factors are determined for a corresponding plurality of scattering mediums.
